(19) United States
(12) Patent Application Publication
(10) Pub. No.: US 2026/0215473 A1
(43) Pub. Date: Jul. 30, 2026

(54) PRODUCTION TOOL FOR ASSISTING IN WRAPPING AND SHAPING OF WRAP

(71) Applicant: HARVEST GRANDE INTERNATIONAL LLC, Dallas, TX (US)

(72) Inventors: Yongfeng LI, Dallas, TX (US); Cuilian Liang, Dallas, TX (US)

(21) Appl. No.: 19/577,351

(22) Filed: Mar. 24, 2026

(30) Foreign Application Priority Data
Mar. 3, 2026 (CN) 2026202581638

(51) Int. Cl. A23P 20/20; A23P 30/10; B26D 3/08

(52) U.S. Cl. CPC A23P 20/20; A23P 30/10; B26D 3/08; B26D 2210/02

(57) ABSTRACT

A production tool for assisting in wrapping and shaping of a wrap includes: a #-shaped wrap-shaping-assisting mold frame, where a central loading cylinder is formed in the middle of the wrap-shaping-assisting mold frame; a cylinder hole of the central loading cylinder is a central loading hole that runs through the top surface and the bottom surface of the wrap-shaping-assisting mold frame; the wrap-shaping-assisting mold frame is provided with a cutting edge group located on the same plane, at the bottom ends of the wing plates corresponding to the outer peripheral side of the central loading cylinder; and the bottom surface of the wrap-shaping-assisting mold frame is provided with an annular wrapper avoidance groove corresponding to the bottom end of the central loading cylinder.

### CROSS REFERENCE TO RELATED APPLICATIONS

The present disclosure claims the priority to the Chinese patent application with the filing No. 2026202581638, entitled "PRODUCTION TOOL FOR ASSISTING IN WRAPPING AND SHAPING OF WRAP" and filed on March 3, 2026 with the Chinese Patent Office, the contents of which are incorporated herein by reference in their entirety.

### TECHNICAL FIELD

The present disclosure relates to the field of wrap-making tools, and in particular to a production tool for assisting in wrapping and shaping of a wrap.

### BACKGROUND ART

The wrap is portable food formed into a wrapped form by wrapping fillings with a flexible dough sheet or an edible thin sheet material as a base. The wrap belongs to the category of "handheld food", the essence of which is to achieve spatial rearrangement and functional integration of food components through the act of wrapping. From a cross-cultural perspective, the wrap has diverse variations. For example, Mexican burritos use wheat tortillas to wrap meats, beans, etc.; Middle Eastern shawarmas use pita bread to wrap grilled meats and vegetables; East Asian spring rolls use rice paper or thin dough sheet to wrap raw or cooked fillings; and modern fusion wraps often use innovative carriers such as spinach tortillas and whole-wheat tortillas.

Existing tools for producing wraps have the following problems. They lack auxiliary functions, only allows for one use manner of cutting, cannot control the amount of fillings which leads to overflow during wrapping, and perform improper folding, resulting in loose finished products and easy falling of food contents during eating. They also have poor portability, as some tortilla packaging and producing tool bags are not designed with the integration function and disassembly function, increasing the burden on users carrying multiple tools. They have poor durability, as some tortilla packaging and producing tool bags made of unqualified or poor- performing materials are prone to rust and deformation, affecting the service life. They lack integrity, as some tortilla packaging and producing tool bags on the market lack simplicity and smoothness in appearance, and the connections between components of the tool bags are not natural, affecting the overall aesthetics. They are inconvenient to operate, as the tortilla packaging and producing tool bags on the market make the operations of various functions dispersed, resulting in inconvenient operation and adjustment of users and reduced convenience in operating the tools.

Therefore, the problem urgently to be solved by those skilled in the art is how to provide a production tool for assisting in wrapping and shaping of a wrap, which can reduce the difficulty in wrap making, facilitates control of food ingredient amount, and is easy to carry and assemble.

### SUMMARY

In view of this, the present disclosure proposes a production tool for assisting in wrapping and shaping of a wrap, aiming to solve at least one of the above-mentioned technical problems.

To achieve the above objectives, the present disclosure adopts the following technical solutions.

The present disclosure provides a production tool for assisting in wrapping and shaping of a wrap, including: a #-shaped wrap-shaping-assisting mold frame, where a central loading cylinder is formed in the middle of the wrap-shaping-assisting mold frame; a cylinder hole of the central loading cylinder is a central loading hole that runs through the top surface and the bottom surface of the wrap-shaping-assisting mold frame; the wrap-shaping-assisting mold frame is provided with a cutting edge group located on the same plane, at the bottom ends of the wing plates corresponding to the outer peripheral side of the central loading cylinder; and the bottom surface of the wrap-shaping-assisting mold frame is provided with an annular wrapper avoidance groove corresponding to the bottom end of the central loading cylinder.

When the production tool for assisting in wrapping and shaping of a wrap of the present disclosure is in use, the #-shape wrap-shaping-assisting mold frame is placed on a prepared wrapper, the central loading cylinder is aligned with the center part of the wrapper, and pressed downwards gently to use the cutting edge group to impress cutting lines on parts of the wrapper corresponding to the four corner portions of the central loading cylinder, or directly cut the corresponding parts of the wrapper, and the four wrapper scrapes corresponding to the four corner portions of the central loading cylinder are removed. Because the wrapper avoidance groove is designed at the bottom end of the central loading cylinder, parts of the wrapper corresponding to and directly below the four side portions of the central loading cylinder are not cut. Food ingredients or fillings such as cucumber, bacon, cheese, and lettuce are added to the center part of the wrapper through the central loading hole. Through the circumferentially enclosed central loading cylinder, the placement location and height of the food ingredients may be restricted and the amount of food ingredients or fillings may be controlled, facilitating subsequent rolling operation. After the food ingredients or fillings are placed, the wrap-shaping-assisting mold frame is removed, and the parts of the wrapper corresponding to the four side portions of the central loading cylinder are folded upwards to cover the food ingredients or fillings, completing the preparation of the wrap. The present disclosure can quickly remove scraps from the wrapper, accurately control the filling amount, filling height, and filling compactness of the food ingredients or fillings, preventing overflow and leakage, facilitating wrapping and shaping, and reducing the difficulty in making the wrap.

As further improvement to the above technical solution, the wrap-shaping-assisting mold frame includes a first upper pre-cutting blade, a second upper pre-cutting blade, a first lower pre-cutting blade, and a second lower pre-cutting blade;

the bottom end of the first upper pre-cutting blade is sequentially connected in a length direction thereof with a first cutting edge A, a first insertion port A, a first wrapper avoidance groove, a first insertion port B, and a first cutting edge B; the bottom end of the second upper pre-cutting blade is sequentially in a length direction thereof connected with a second cutting edge A, a second insertion port A, a second wrapper avoidance groove, a second insertion port B, and a second cutting edge B; the bottom end of the first lower pre-cutting blade is sequentially in a length direction thereof connected with a third cutting edge A, a third wrapper avoidance groove, and a third cutting edge B; and the bottom end of the second lower pre-cutting blade is sequentially in a length direction thereof connected with a fourth cutting edge A, a fourth wrapper avoidance groove, and a fourth cutting edge B; and

when the first upper pre-cutting blade and the second upper pre-cutting blade are provided horizontally opposite to and spaced from each other, the first lower pre-cutting blade can be inserted into the first insertion port A and the second insertion port A, and the second lower pre-cutting blade can be inserted into the first insertion port B and the second insertion port B, to be spliced together to form a #-shaped wrap-shaping-assisting mold frame with the central loading cylinder; the first cutting edge A, the first cutting edge B, the second cutting edge A, the second cutting edge B, the third cutting edge A, the third cutting edge B, the fourth cutting edge A, and the fourth cutting edge B distributed at the bottom end face of the wrap- shaping-assisting mold frame jointly constitute the cutting edge group located on the same plane; and the first wrapper avoidance groove, the second wrapper avoidance groove, the third wrapper avoidance groove and the fourth wrapper avoidance groove distributed at the bottom end face of the wrap-shaping-assisting mold frame are sequentially connected end to end and communicate with each other, so as to jointly form the annular wrapper avoidance groove.

The beneficial effects of the above technical solution are: the wrap-shaping-assisting mold frame is designed to be in the splicable and detachable form, and when in use, the first upper pre-cutting blade, the second upper pre-cutting blade, the first lower pre-cutting blade and the second lower pre-cutting blade may be quickly assembled by aligning the insertion ports, and are easy to carry after disassembly.

As further improvement to the above technical solution, the groove bottom surfaces of the first wrapper avoidance groove, the second wrapper avoidance groove, the third wrapper avoidance groove and the fourth wrapper avoidance groove distributed at the bottom end face of the wrap-shaping-assisting mold frame are located on the same plane.

As further improvement to the above technical solution, the top end of the first lower pre-cutting blade is provided with a third insertion port A and a third insertion port B in one-to-one correspondence with the two ends of the third wrapper avoidance groove in the length direction; and the top end of the second lower pre-cutting blade is provided with a fourth insertion port A and a fourth insertion port B in one-to-one correspondence with the two ends of the fourth wrapper avoidance groove in the length direction; and

when the first upper pre-cutting blade and the second upper pre-cutting blade are provided horizontally opposite to and spaced from each other, the first lower pre-cutting blade can be inserted into the first insertion port A and the second insertion port A, the second lower pre-cutting blade can be inserted into the first insertion port B and the second insertion port B, the first upper pre-cutting blade can be inserted into the third insertion port A and the fourth insertion port A, and the second upper pre-cutting blade can be inserted into the third insertion port B and the fourth insertion port B, to be spliced together to form the #-shaped wrap-shaping-assisting mold frame with the central loading cylinder.

The beneficial effects of the above technical solution are: during insertion, the first insertion port A is aligned vertically with the third insertion port A, the second insertion port A is aligned vertically with the third insertion port B, the first insertion port B is aligned vertically with the fourth insertion port A, and the second insertion port B is aligned vertically with the fourth insertion port B for performing insertion. After the insertion, the first upper pre-cutting blade, the second upper pre-cutting blade, the first lower pre-cutting blade, and the second lower pre-cutting blade can all be held in place by being adaptively inserted into the corresponding insertion ports, which can improve the stability of the assembled tool.

As further improvement to the above technical solution, the first upper pre-cutting blade and the second upper pre-cutting blade have the same structure; and the first lower pre-cutting blade and the second lower pre-cutting blade have the same structure.

As further improvement to the above technical solution, the first cutting edge A, the first cutting edge B, the second cutting edge A, the second cutting edge B, the third cutting edge A, the third cutting edge B, the fourth cutting edge A, and the fourth cutting edge B are all serrated cutting edges or straight cutting edges.

The beneficial effects of the above technical solution are: each cutting edge functions to pre-impress an easy-to-tear cutting line on the wrapper, thereby making it easy to remove the scraps of the wrapper, without the need for performing cutting with additional tools.

As further improvement to the above technical solution, the first upper pre-cutting blade, the second upper pre-cutting blade, the first lower pre-cutting blade, and the second lower pre-cutting blade are all elongated blades and have the same length, width, and thickness; the first cutting edge A, the first cutting edge B, the second cutting edge A, the second cutting edge B, the third cutting edge A, the third cutting edge B, the fourth cutting edge A, and the fourth cutting edge B all have the same length; and the first wrapper avoidance groove, the second wrapper avoidance groove, the third wrapper avoidance groove, and the fourth wrapper avoidance groove all have the same length.

As further improvement to the above technical solution, the first upper pre-cutting blade, the second upper pre-cutting blade, the first lower pre-cutting blade, and the second lower pre-cutting blade are all stainless steel blades.

The beneficial effects of the above technical solution are: the use of stainless steel blades can ensure the technical requirements of high temperature resistance, rust resistance and no toxicity.

As can be seen from the above technical solutions, compared with the prior art, the present disclosure discloses a production tool for assisting in wrapping and shaping of a wrap, which has the following advantages and beneficial effects.

1. The present disclosure has simple assembly and disassembly: only needing to align and assemble the upper and lower pre-cutting blades according to the positions of the insertion ports.

2. After assembling the tools, the present disclosure has a restricted area for fillings or food ingredients at the central part, facilitating controlling the amount and the filling height of fillings and food ingredients, so that the fillings are not easy to overflow during wrapping.

3. The present disclosure has simple operation manner. The product aims to systematically solve the pain points of making wraps such as tortillas by simple pressing, cutting, and filling steps. One of the core innovations of the product is that it can "impress" easy-to- tear cutting lines on the wrapper in advance, eliminating the need for users to use additional tools for cutting, greatly reducing the production difficulty and improving production efficiency.

### BRIEF DESCRIPTION OF DRAWINGS

To more clearly illustrate the technical solutions in the embodiments of the present disclosure or the prior art, the drawings required to be used in the description of the embodiments or the prior art will be briefly introduced below. Obviously, the drawings described below are only embodiments of the present disclosure. For those ordinarily skilled in the art, other drawings may be obtained based on the provided drawings without paying creative effort.

FIG. 1 is an exploded view of a production tool for assisting in wrapping and shaping of a wrap according to the present disclosure.

FIG. 2 is a schematic structural view of the production tool for assisting in wrapping and shaping of a wrap according to the present disclosure in the assembly state.

FIG. 3 is a schematic view of the process of using the production tool for assisting in wrapping and shaping of a wrap according to the present disclosure to make a wrap.

In the drawings: 1. first upper pre-cutting blade; 11. first cutting blade A; 12. first insertion port A; 13. first wrapper avoidance groove; 14. first insertion port B; 15. first cutting edge B; 2. second upper pre-cutting blade; 21. second cutting edge A; 22. second insertion port A; 23. second wrapper avoidance groove; 24. second insertion port B; 25. second cutting edge B; 3. first lower pre-cutting blade; 31. third cutting edge A; 32. third insertion port A; 33. third wrapper avoidance groove; 34. third insertion port B; 35. third cutting edge B; 4. second lower pre-cutting blade; 41. fourth cutting edge A; 42. fourth insertion port A; 43. fourth wrapper avoidance groove; 44. fourth insertion port B; 45. fourth insertion port B; 5. central loading cylinder; 51. central loading hole; 6. wing plate; 7. wrapper; 71. wrapper scrap.

### DETAILED DESCRIPTION OF EMBODIMENTS

The embodiments of the present disclosure are described in detail below. Examples of these embodiments are shown in the drawings, where the same or similar reference numerals denote the same or similar elements or elements having the same or similar functions throughout. The embodiments described below with reference to the drawings are exemplary and intended to explain the present disclosure, and should not be construed as limiting the present disclosure.

In the description of the present disclosure, it should be understood that the orientation or positional relationship indicated by the terms "upper", "lower", "front", "rear", "left", "right", "vertical", "horizontal", "top", "bottom", "inner", "outer", etc., are the orientation or positional relationship shown in the drawings, only for facilitating describing the present disclosure and simplifying the description, rather than indicating or implying that the device or element referred to must have a specific orientation, or be constructed and operated in a specific orientation. Therefore, they should not be construed as limitations on the present disclosure.

Furthermore, the terms "first" and "second" are used for descriptive purposes only and should not be construed as indicating or implying importance in relativity or implicitly specifying the number of technical features indicated. Thus, a feature defined as "first" or "second" may explicitly or implicitly include one or more features. In the description of the present disclosure, "a plurality of/multiple" means two or more than two, unless otherwise explicitly specified.

In the present disclosure, unless otherwise explicitly specified and defined, the terms "installation", "connection", "joining" and "fixing", etc., should be interpreted broadly. For example, they may be fixed connection, detachable connection, or integral connection; may be mechanical connection or electrical connection; may be direct connection or indirect connection through an intermediate medium; or may be internal communication of two components or interaction between two components. Those ordinarily skilled in the art may understand the specific meaning of the above terms in the present disclosure according to the specific circumstances.

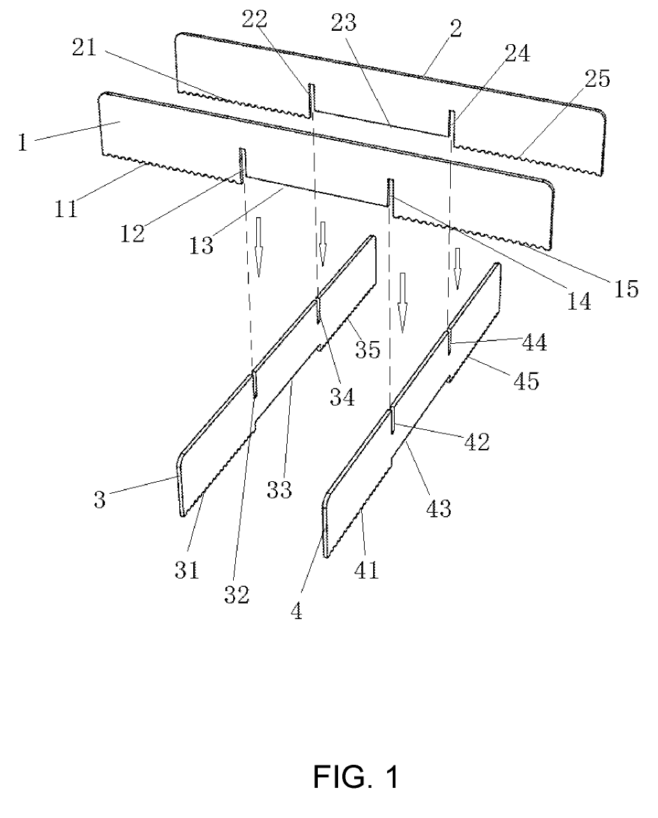

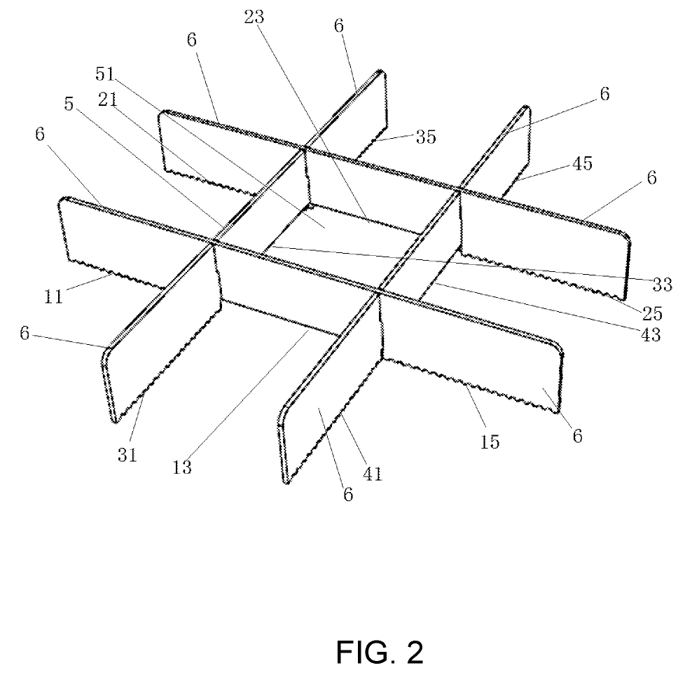

According to embodiments of the present disclosure, as shown in FIG. 1 and FIG. 2, a production tool for assisting in wrapping and shaping of a wrap includes: a #-shaped wrap- 14 shaping-assisting mold frame.

A central loading cylinder 5 is formed in the middle of the wrap-shaping-assisting mold frame; the cylinder hole of the central loading cylinder 5 is a central loading hole 51 that runs through the top surface and the bottom surface of the wrap-shaping-assisting mold frame; the wrap-shaping-assisting mold frame is provided with a cutting edge group located on the same plane, at the bottom ends of the wing plates 6 corresponding to the outer peripheral side of the central loading cylinder 5; and the bottom surface of the wrap- shaping-assisting mold frame is provided with an annular wrapper avoidance groove corresponding to the bottom end of the central loading cylinder 5.

When the production tool for assisting in wrapping and shaping of a wrap of the present embodiment is in use, the #-shape wrap-shaping-assisting mold frame is placed on a prepared wrapper, the central loading cylinder 5 is aligned with the center part of the wrapper 7, and pressed downwards gently to use the cutting edge group to impress cutting lines on parts of the wrapper 7 corresponding to the four corner portions of the central loading cylinder 5, or directly cut the corresponding parts of the wrapper, and the four wrapper scrapes 71 corresponding to the four corner portions of the central loading cylinder 5 are removed. Because a wrapper avoidance groove is designed corresponding to the bottom end of the central loading cylinder 5, parts of the wrapper corresponding to and directly below the four side portions of the central loading cylinder 5 are not cut. Food ingredients or fillings such as cucumber, bacon, cheese, and lettuce are added to the center part of the wrapper through the central loading hole 51. Through the circumferentially enclosed central loading cylinder 5, the placement location and height of the food ingredients may be restricted and the amount of food ingredients or fillings may be controlled, facilitating subsequent rolling operation. After the food ingredients or fillings are placed, the wrap-shaping-assisting mold frame is removed, and the parts of the wrapper corresponding to the four side portions of the central loading cylinder 5 are folded upwards to cover the food ingredients or fillings, completing the production of the wrap. The present disclosure can quickly remove scraps from the wrapper, accurately control the filling amount, filling height, and filling compactness of the food ingredients or fillings, preventing overflow and leakage, facilitating wrapping and shaping, and reducing the difficulty in making the wrap.

In some embodiments, the wrap-shaping-assisting mold frame includes a first upper pre-cutting blade 1, a second upper pre- cutting blade 2, a first lower pre-cutting blade 3, and a second lower pre-cutting blade 4;

the bottom end of the first upper pre-cutting blade 1 is sequentially connected in a length direction thereof with a first cutting edge A 11, a first insertion port A 12, a first wrapper avoidance groove 13, a first insertion port B 14, and a first cutting edge B 15; the bottom end of the second upper pre-cutting blade 2 is sequentially connected in a length direction thereof with a second cutting edge A 21, a second insertion port A 22, a second wrapper avoidance groove 23, a second insertion port B 24, and a second cutting edge B 25; the bottom end of the first lower pre-cutting blade 3 is sequentially connected in a length direction thereof with a third cutting edge A 31, a third wrapper avoidance groove 33, and a third cutting edge B 35; and the bottom end of the second lower pre- cutting blade 4 is sequentially connected in a length direction thereof with a fourth cutting edge A 41, a fourth wrapper avoidance groove 43, and a fourth cutting edge B 45; and

when the first upper pre-cutting blade 1 and the second upper pre-cutting blade 2 are provided horizontally opposite to and spaced from each other, the first lower pre-cutting blade 3 can be inserted into the first insertion port A 12 and the second insertion port A 22, and the second lower pre-cutting blade 4 can be inserted into the first insertion port B 14 and the second insertion port B 24, to be spliced together to form the #-shaped wrap-shaping-assisting mold frame with the central loading cylinder 5; the first cutting edge A 11, the first cutting edge B 15, the second cutting edge A 21, the second cutting edge B 25, the third cutting edge A 31, the third cutting edge B 35, the fourth cutting edge A 41, and the fourth cutting edge B 45 distributed at the bottom end face of the wrap-shaping- assisting mold frame jointly constitute the cutting edge group located on the same plane; and the first wrapper avoidance groove 13, the second wrapper avoidance groove 23, the third wrapper avoidance groove 33 and the fourth wrapper avoidance groove 43 distributed at the bottom end face of the wrap-shaping-assisting mold frame are sequentially connected end to end and communicate with each other, so as to jointly form the annular wrapper avoidance groove.

The wrap-shaping-assisting mold frame is designed to be in the splicable and detachable form, and when in use, the first upper pre-cutting blade 1, the second upper pre-cutting blade 2, the first lower pre-cutting blade 3 and the second lower pre-cutting blade 4 may be quickly assembled by aligning the insertion ports, and are easy to carry after disassembly.

In some embodiments, the groove bottom surfaces of the first wrapper avoidance groove 13, the second wrapper avoidance groove 23, the third wrapper avoidance groove 33 and the fourth wrapper avoidance groove 43 distributed at the bottom end face of the wrap-shaping-assisting mold frame are located on the same plane.

In some embodiments, the top end of the first lower pre- cutting blade 3 is provided with a third insertion port A 32 and a third insertion port B 34 in one-to-one correspondence with the two ends of the third wrapper avoidance groove 33 in the length direction thereof; and the top end of the second lower pre-cutting blade 4 is provided with a fourth insertion port A 42 and a fourth insertion port B 44 in one-to-one correspondence with the two ends of the fourth wrapper avoidance groove 43 in the length direction thereof; and

when the first upper pre-cutting blade 1 and the second upper pre-cutting blade 2 are provided horizontally opposite to and spaced from each other, the first lower pre-cutting blade 3 can be inserted into the first insertion port A 12 and the second insertion port A 22, the second lower pre-cutting blade 4 can be inserted into the first insertion port B 14 and the second insertion port B 24, the first upper pre-cutting blade 1 can be inserted into the third insertion port A 32 and the fourth insertion port A 42, and the second upper pre-cutting blade 2 can be inserted into the third insertion port B 34 and the fourth insertion port B 44, to be spliced together to form the #-shaped wrap-shaping-assisting mold frame with the central loading cylinder 5.

During insertion, the first insertion port A 12 is aligned vertically with the third insertion port A 32, the second insertion port A 22 is aligned vertically with the third insertion port B 34, the first insertion port B 14 is aligned vertically with the fourth insertion port A 42, and the second insertion port B 24 is aligned vertically with the fourth insertion port B 44 for performing insertion. After the insertion, the first upper pre-cutting blade 1, the second upper pre-cutting blade 2, the first lower pre-cutting blade 3, and the second lower pre-cutting blade 4 can all be held in place by being adaptively inserted into the corresponding insertion ports, which can improve the stability of the assembled tool.

In some embodiments, the first upper pre-cutting blade 1 and the second upper pre-cutting blade 2 have the same structure; and the first lower pre-cutting blade 3 and the second lower pre-cutting blade 4 have the same structure..

In some embodiments, the first cutting edge A 11, the first cutting edge B 15, the second cutting edge A 21, the second cutting edge B 25, the third cutting edge A 31, the third cutting edge B 35, the fourth cutting edge A 41, and the fourth cutting edge B 45 are all serrated cutting edges or straight cutting edges.

Each cutting edge functions to pre-impress an easy-to-tear cutting line on the wrapper, thereby making it easy to remove the scraps of the wrapper, without the need for performing cutting with additional tools.

In some embodiments, the first upper pre-cutting blade 1, the second upper pre-cutting blade 2, the first lower pre-cutting blade 3, and the second lower pre-cutting blade 4 are all elongated blades and have the same length, width, and thickness; the first cutting edge A 11, the first cutting edge B 15, the second cutting edge A 21, the second cutting edge B 25, the third cutting edge A 31, the third cutting edge B 35, the fourth cutting edge A 41, and the fourth cutting edge B 45 all have the same length; and the first wrapper avoidance groove 13, the second wrapper avoidance groove 23, the third wrapper avoidance groove 33, and the fourth wrapper avoidance groove 43 all have the same length.

In some embodiments, the first upper pre-cutting blade 1, the second upper pre-cutting blade 2, the first lower pre-cutting blade 3, and the second lower pre-cutting blade 4 are all stainless steel blades.

In some embodiments, the first upper pre-cutting blade 1 has a length of 5-40 cm, a width of 2-5 cm, and a thickness of 1.5-3 mm.

Specifically, the first upper pre-cutting blade 1 has a length of 237 mm, a width of 35 mm, and a thickness of 2 mm. The first cutting edge A 11, the first cutting edge B 15, and the first wrapper avoidance groove 13 have the same length, and the sum of the lengths of the first cutting edge A 11, the first cutting edge B 15, and the first wrapper avoidance groove 13 is equal to the length of the first upper pre-cutting blade 1.

Specifically, the widths of the first insertion port A 12, the first insertion port B 14, the second insertion port A 22, the second insertion port B 24, the third insertion port A 32, the third insertion port B 34, the fourth insertion port A 42, and the fourth insertion port B 44 are all the same and equal to or slightly greater than the thickness of the first pre-cutting blade 1, to facilitate smooth insertion and assembly. The depths of the first insertion port A 12, the first insertion port B 14, the second insertion port A 22, the second insertion port B 24, the third insertion port A 32, the third insertion port B 34, the fourth insertion port A 42, and the fourth insertion port B 44 are equal to or slightly greater than half the width of the first upper pre-cutting blade 1, to ensure that after the first upper pre- cutting blade 1, the second upper pre-cutting blade 2, the first lower pre-cutting blade 3, and the second lower pre-cutting blade 4 are inserted to form the wrap-shaping-assisting mold frame, the first cutting edge A 11, the first cutting edge B 15, the second cutting edge A 21, the second cutting edge B 25, the third cutting edge A 31, the third cutting edge B 35, the fourth cutting edge A 41, and the fourth cutting edge B 45 distributed on its bottom end face can be located on the same plane.

Specifically, the bottom end face of the cutting edge group of the wrap-shaping-assisting mold frame and the groove bottom surface of the wrapper avoidance groove are parallel to each other and have a spacing therebetween designed to be equal to or slightly less than the thickness of the wrapper. That is, after the bottom end of the cutting edge group cuts the wrapper and abuts against the upper surface of the working board on which the wrapper is placed, the bottom end of the central loading cylinder 5 (i.e. the groove bottom surface of the wrapper avoidance groove) presses slightly against the upper surface of the wrapper. At this time, the upper surface of the wrapper can seal the lower opening of the central loading hole 51, thereby achieving the purpose of preventing leakage.

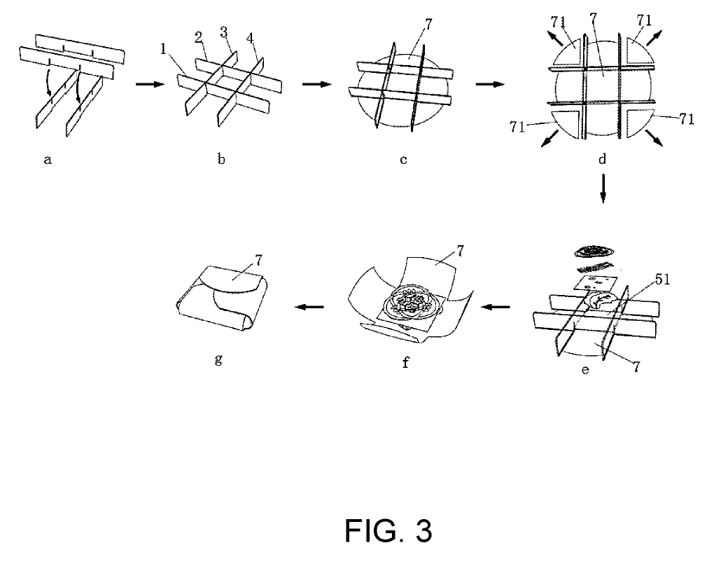

As shown in FIG. 3, a, b, c, d, e, f, and g in FIG. 3 illustrate the wrap making process including assembling tools, pre-making tearable cutting lines on the wrapper 7, removing wrapper scraps 71, filling food ingredients though the central loading hole 51, removing the wrap-shaping-assisting mold frame, and flipping two sides of the wrapper to perform wrapping.

Specifically, taking the production of a corn tortilla wrap as an example, the process of wrapping and shaping the corn tortilla wrap is as follows: first, assembling the cutter (i.e., the wrap- shaping-assisting mold frame), then taking out the corn tortilla wrapper, roughly aligning the center of the cutter with the center part of the corn tortilla wrapper, and placing the cutter on the corn tortilla wrapper; then pressing down the cutter slightly to impress the cutting lines, removing the four wrapper scrapes 71 of the corn tortilla wrapper after the pressing, and then adding one's favorite food ingredients such as cucumber, bacon, cheese, lettuce, etc. in the center area of the cutter, where since the center area of the cutter is closed, the placement location and height of the food ingredients may be restricted, facilitating subsequent rolling process; and after the placing, removing the cutter, and then folding the four sides of the core tortilla wrapper upwards to complete the production of the corn tortilla wrap.

For the production tool for assisting in wrapping and forming of a wrap of the present disclosure, it is made of a material of stainless steel to ensure corrosion resistance, rust resistance, and no toxicity, and avoid the risk of easy damage. The integrated design of this tool effectively reduces tool storage space and reduces the space occupied in the kitchen or outdoor camping area. It features easy cleaning and reduced hygiene risks. The product has a simple structure, and the flat structural surface after disassembly allows for deep cleaning of oil stains of the detachable structure, avoiding the safety hazards caused by bacterial growth due to the difficulty in cleaning gaps in traditional corn tortilla packaging and producing tool bags.

The present disclosure provides a solution for DIY of Mexican burrito; and can help home users or catering novices to easily separate the wrapper from and combine it with fillings without any cooking skills, and easily neatly make regular-shaped Mexican burrito with fillings that are not easy to spill, in a standardized manner, thus improving the dining experience.

By improving existing food forms such as Mexican burrito or processing methods, the product tool for assisting in wrapping and shaping of a wrap of the present disclosure can be assembled during outdoor picnics to make foods such as Mexican burritos. This tool set may be made of a material of food-grade stainless steel, ensuring stable material properties and effectively guaranteeing the tool's sturdiness and durability. Alternatively, depending on the practical application requirements, it may be made of food-grade plastics such as PP (polypropylene) or food-grade ABS; or biodegradable/environmentally friendly composite materials such as bamboo fiber composite material or food-grade degradable plastics (such as PLA). This product may be applied to various scenarios such as homemade fast food, outdoor travel food, restaurant delivery, and children's fun meals, reducing the burden on users who need to carry multiple tools.

In the description of this specification, the description with reference to terms such as "one embodiment", "some embodiments", "example", "specific example" or "some examples", etc., indicate that a specific feature, structure, material, or characteristic described in connection with that embodiment or example is included in at least one embodiment or example of the present disclosure. In this specification, the illustrative expressions of the above terms do not necessarily refer to the same embodiment or example. Furthermore, the specific features, structures, materials, or characteristics described may be combined in suitable manner in any one or more embodiments or examples. In addition, those skilled in the art may combine and integrate the different embodiments or examples described in this specification.

Although embodiments of the present disclosure have been shown and described above, it should be understood that the above embodiments are exemplary and should not be construed as limiting the present disclosure. Those ordinarily skilled in the art can make changes, modifications, substitutions and variations to the above embodiments within the scope of the present disclosure.

1. A product tool for assisting in wrapping and shaping of a wrap, comprising: a #-shaped wrap-shaping-assisting mold frame, wherein a central loading cylinder is formed in middle of the wrap-shaping-assisting mold frame; a cylinder hole of the central loading cylinder is a central loading hole running through a top surface and a bottom surface of the wrap-shaping-assisting mold frame; the wrap-shaping-assisting mold frame is provided with a cutting edge group located on a same plane, at bottom ends of wing plates corresponding to an outer peripheral side of the central loading cylinder; and the bottom surface of the wrap-shaping-assisting mold frame is provided with an annular wrapper avoidance groove corresponding to a bottom end of the central loading cylinder.

2. The production tool for assisting wrapping and shaping of a wrap according to claim 1, where the wrap-shaping-assisting mold frame includes a first upper pre-cutting blade, a second upper pre-cutting blade, a first lower pre-cutting blade, and a second lower pre-cutting blade;
a bottom end of the first upper pre-cutting blade is sequentially connected in a length direction thereof with a first cutting edge A, a first insertion port A, a first wrapper avoidance groove, a first insertion port B, and a first cutting edge B; a bottom end of the second upper pre-cutting blade is sequentially connected in a length direction thereof with a second cutting edge A, a second insertion port A, a second wrapper avoidance groove, a second insertion port B, and a second cutting edge B; a bottom end of the first lower pre-cutting blade is sequentially connected in a length direction thereof with a third cutting edge A, a third wrapper avoidance groove, and a third cutting edge B; and a bottom end of the second lower pre-cutting blade is sequentially connected in a length direction thereof with a fourth cutting edge A, a fourth wrapper avoidance groove, and a fourth cutting edge B; and
when the first upper pre-cutting blade and the second upper pre-cutting blade are provided horizontally opposite to and spaced from each other, the first lower pre-cutting blade can be inserted into the first insertion port A and the second insertion port A, and the second lower pre-cutting blade can be inserted into the first insertion port B and the second insertion port B, to be spliced together to form the #-shaped wrap-shaping-assisting mold frame with the central loading cylinder; the first cutting edge A, the first cutting edge B, the second cutting edge A, the second cutting edge B, the third cutting edge A, the third cutting edge B, the fourth cutting edge A, and the fourth cutting edge B distributed at a bottom end face of the wrap-shaping-assisting mold frame jointly constitute the cutting edge group located on the same plane; and the first wrapper avoidance groove, the second wrapper avoidance groove, the third wrapper avoidance groove and the fourth wrapper avoidance groove distributed at the bottom end face of the wrap-shaping-assisting mold frame are sequentially connected end to end and communicate with each other, to jointly form the annular wrapper avoidance groove.

3. The production tool for assisting in wrapping and shaping of a wrap according to claim 2, wherein groove bottom surfaces of the first wrapper avoidance groove, the second wrapper avoidance groove, the third wrapper avoidance groove and the fourth wrapper avoidance groove distributed at the bottom end face of the wrap-shaping-assisting mold frame are located on the same plane.

4. The production tool for assisting in wrapping and shaping of a wrap according to claim 3, wherein a top end of the first lower pre-cutting blade is provided with a third insertion port A and a third insertion port B in one-to-one correspondence with two ends of the third wrapper avoidance groove in a length direction thereof; and a top end of the second lower pre-cutting blade is provided with a fourth insertion port A and a fourth insertion port B in one-to-one correspondence with two ends of the fourth wrapper avoidance groove in a length direction thereof; and
when the first upper pre-cutting blade and the second upper pre-cutting blade are provided horizontally opposite to and spaced from each other, the first lower pre-cutting blade can be inserted into the first insertion port A and the second insertion port A, the second lower pre-cutting blade can be inserted into the first insertion port B and the second insertion port B, the first upper pre-cutting blade can be inserted into the third insertion port A and the fourth insertion port A, and the second upper pre-cutting blade can be inserted into the third insertion port B and the fourth insertion port B, to be spliced together to form the #-shaped wrap-shaping-assisting mold frame with the central loading cylinder.

5. The production tool for assisting in wrapping and shaping of a wrap according to claim 4, wherein the first upper pre-cutting blade and the second upper pre-cutting blade have same structure; and the first lower pre-cutting blade and the second lower pre-cutting blade have same structure.

6. The production tool for assisting in wrapping and shaping of a wrap according to claim 4, wherein the first cutting edge A, the first cutting edge B, the second cutting edge A, the second cutting edge B, the third cutting edge A, the third cutting edge B, the fourth cutting edge A, and the fourth cutting edge B are all serrated cutting edges or straight cutting edges.

7. The production tool for assisting in wrapping and shaping of a wrap according to claim 4, wherein the first upper pre-cutting blade, the second upper pre-cutting blade, the first lower pre-cutting blade, and the second lower pre-cutting blade are all elongated blades and have same length, width, and thickness; the first cutting edge A, the first cutting edge B, the second cutting edge A, the second cutting edge B, the third cutting edge A, the third cutting edge B, the fourth cutting edge A, and the fourth cutting edge B all have same length; and the first wrapper avoidance groove, the second wrapper avoidance groove, the third wrapper avoidance groove, and the fourth wrapper avoidance groove all have same length.

8. The production tool for assisting in wrapping and shaping of a wrap according to claim 4, wherein the first upper pre-cutting blade, the second upper pre-cutting blade, the first lower pre-cutting blade, and the second lower pre-cutting blade are all stainless steel blades.
